(19) United States
(12) Patent Application Publication
(10) Pub. No.: US 2006/0157997 A1
(43) Pub. Date: Jul. 20, 2006

(54) Multi-positionable rotary vacuum head for product processing

(75) Inventors: William A. Meredith, Rochester, NY (US); David F. Hall, Naples, NY (US); Robert W. Sanford, Taylors, SC (US); Robert M. Wegner, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/036,655

(22) Filed: Jan. 14, 2005

(51) Int. Cl. B25J 15/06

(52) U.S. Cl. 294/65

(57) ABSTRACT

An assembly is presented. The assembly includes a rotatable cylinder including product-holding members positioned on the circumference of the cylinder. Several cylinder passageways are deployed within the cylinder, which provides fluid communication between the product holding members and a vacuum. As such, a suction force may be applied from the vacuum through the cylinder passageway to the product-holding member. A locating pin is deployed on one end of the rotating cylinder. The locating pin enables rotation of the cylinder and a positive stop of the cylinder in an aligned position. The locating pin works in conjunction with an O-ring so that vacuum is only applied to one cylinder and one set of product holding members when the locating pin is locked in the positive stop position.

### FIELD OF THE INVENTION

The invention relates generally to the field of automation, and in particular to manufacturing automation. More specifically, the invention relates to a pick-and-place unit used for automation on an assembly line.

### BACKGROUND OF THE INVENTION

The present invention is directed to an assembly for picking up, repositioning, and releasing objects. In the manufacturing industry, these assemblies are often referred to as “pick-and-place” units. The pick-and-place units enable automation of a manufacturing line by enhancing the ability of operators or replacing operators. The pick-and-place units pick up an object enabling a function to be performed on the object or enabling the object to be repositioned. Typically, some type of suction device is integrated into the pick-and-place unit so that when vacuum or suction is applied, the object is held in place by the pick-and-place unit and then the assembly can move the objects. The objects may be anything from small items, to packaging materials, to car doors.

In conventional systems, pick-and-place units may be used for packaging. In packaging, the pick-and-place unit may acquire an object and accurately place the object into a package. The pick-and-place unit may also manipulate the package so that the package may be repositioned to receive an object or the package may be repositioned for labeling.

In conventional manufacturing systems, a group of products in the manufacturing line are typically oriented so that they can be picked-up by the pick-and-place unit. The object or objects may move toward the pick-and-place unit on a conveyor belt. The pick-and-place unit may then pick up the objects and reposition the objects. Therefore, the pick-and-place unit has to be configured to match the objects on the conveyor line or the object on the conveyor line have to be oriented so that the pick-and-place unit can access the object. For example, if a pick-and-place unit has four suction subassemblies for picking up four objects, objects may be presented on the conveyor line in groups of four so that the pick-and-place unit can pick-up and reorient or reposition the objects.

However, given the need for economic efficiencies in most factories, a single conveyor line may be used for many products that require many different types of objects. As a result, a single pick-and-place unit may be implemented to work with objects positioned in a variety of different configurations. When there are a large number of product changes and object changes, the ability to change the pick-and-place unit to accommodate new object configurations quickly and accurately is valuable and leads to economic efficiencies.

In conventional pick-and-place units, it takes hours to convert the pick-and-place unit from one configuration to another. Conventional suction/vacuum designs were not easily interchanged and tool format changes could not be made. For example, swapping vacuum heads for a different format (i.e., grouping of objects) required mechanical disassembly. An alignment procedure had to be done to ensure proper object placement and bearing alignment. As a result, it was common in the manufacturing industry to set up very long runs of similarly configured objects. Operators would do everything possible to avoid changing the machine to a different format, since changing the pick-and-place unit was so inefficient.

Thus, there is a need for an assembly, such as a pick-and-place unit, that can be quickly and accurately changed to accommodate new object configurations.

### SUMMARY OF THE INVENTION

The present invention is directed to overcoming one or more of the problems set forth above. Briefly summarized, according to one aspect of the present invention, an assembly is presented that quickly and accurately changes orientation to accommodate new object configurations.

A vacuum element for product processing, comprises a rotary cylinder having at least one cylinder passageway for receiving a vacuum, said rotary cylinder having affixed to a circumferential portion thereof a plurality of spaced product holding members, each of said spaced product holding members comprising a plurality of cavities for at least partially enclosing a single product therein and a vacuum cup passageway extending beneath said plurality of cavities and connecting to the cylinder passageway; whereby when any one of said spaced product holding members is rotated into fluid communications with said cylinder passageway, a select one of said product-holding members releasable retains the product in said plurality of cavities.

A vacuum element for product processing, comprises a rotary head having a cylinder passageway deployed therein, the rotary head having affixed to a circumferential portion thereof a product locator bar, the product locator bar further comprising a vacuum head, the vacuum head including at least one vacuum chamber therein, the vacuum head including a chamber passageway coupling the vacuum chamber to the cylinder passageway; whereby when the rotary head is rotated to a defined stop position, the chamber passageway is aligned with the cylinder passageway to provide a suction force in the vacuum chamber.

A vacuum element for product processing, comprises a rotary head having a cylinder passageway deployed therein, the rotary head having affixed to a circumferential portion thereof a plurality of product locator bars, each of the plurality of product locator bars further comprising a plurality of vacuum heads, the plurality of vacuum heads each including at least one vacuum chamber therein, wherein each of the at least one vacuum chambers is coupled to a chamber passageway providing fluid communication between each of the at least one vacuum chambers and the cylinder passageway when the rotary head is rotated to a defined stop position.

In one embodiment of the present invention, a pick-and-place unit is presented. The pick-and-place unit enables the quick changeover between formats without the use of additional tools or without having to disassemble parts. In addition, format changes may be accomplished without rerouting vacuum lines. A single and common vacuum supply is implemented. The vacuum supply is isolated to the tooling in use and is automatically switched over when the head of the pick-and-place unit is rotated. Lastly, the pick-and-place unit implemented in accordance with the teachings of the present invention does not require any alignment or calibration because of a positive stop feature. Further, the spacing for each step is fixed, which eliminates the need for adjustments or individual product tooling setups.

The present invention has the following advantages:

Quick changeover between different product formats without tools or any disassembly of parts, fasteners or re-routing of vacuum supply lines.

A single and common vacuum supply is isolated to only the tooling in use, automatically through internal porting, when the tooling is rotated to the production position.

A rotational, three position head requires no alignment after changeover due to its positive locating stop mechanism, which provides accurate repeatability regardless of rotational direction.

Product spacing is fixed and eliminates the need for adjustment of individual product tooling.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an isometric view of the three-position rotary vacuum head displayed in one of three positions;

FIG. 2 is a bottom view of the three-position rotary vacuum head showing two of the three different product locator bars;

FIG. 3 is a cross-section of FIG. 2 from B-B showing one of the three internal chambers;

FIG. 4 is a cross-section of FIG. 2 along section A-A detailing a cross section of the vacuum rotary head, highlighting the vacuum suction cups;

FIG. 5A is a cross-section of FIG. 2 along section C-C detailing a cross section of the inside of vacuum inlet mounting block; and

FIG. 5B is a cross-section of FIG. 2 along section C-C detailing a cross section of the outside of vacuum inlet mounting block.

To facilitate understanding, identical reference numerals have been used, where possible, to designate identical elements that are common to the figures.

### DETAILED DESCRIPTION OF THE INVENTION

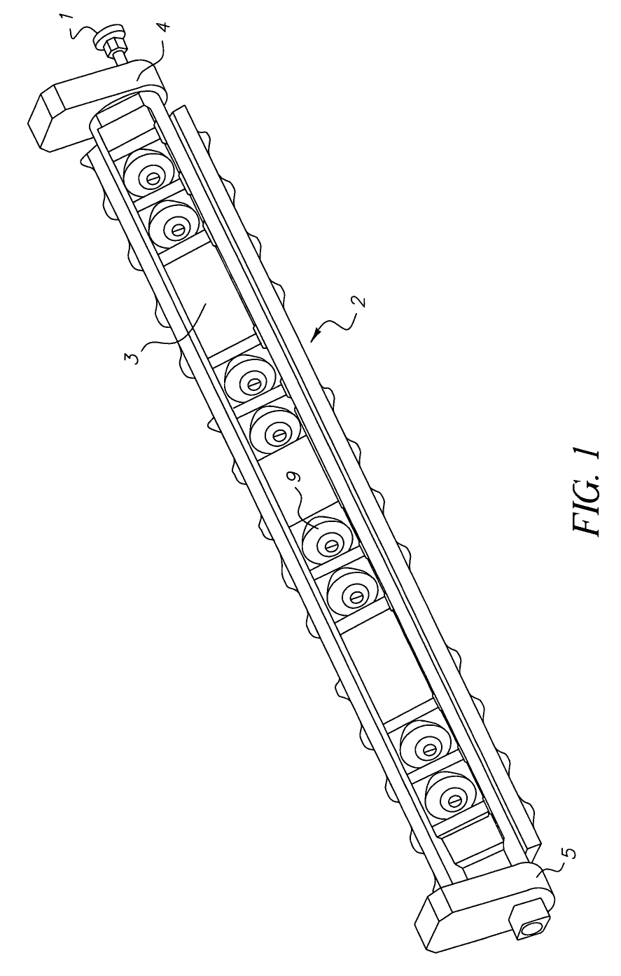

FIG. 1 is an isometric view of the three-position rotary vacuum head displayed in one of three positions. A rotary head 2 is shown positioned between a locating pin mounting block 4 and a vacuum inlet mounting block 5. In one embodiment, the rotary head 2 may assume three positions and is able to be rotated manually or automatically. The locating pin mounting block 4 is provided to position the assembly shown in FIG. 1 into a larger apparatus and also to receive and coordinate the interaction of a locating pin 1 with the rotary head 2. The locating pin 1 interfaces with the rotary head 2 through the locating pin mounting block 4 to position the rotary head 2 in one of three positions. The vacuum inlet mounting block 5 is provided to position the assembly shown in FIG. 1 into a larger apparatus and also to receive a vacuum to provide a suction force in the rotary head 2.

The rotary head 2 also includes at least one product locator bar 3 positioned on the circumference of the rotary head 2. The product locator bar 3 includes a number of vacuum cups 9 for interfacing with objects. Using suction, the vacuum cup 9 is able to hold on to an object until the vacuum causing the suction is discontinued and the object is released. Although only one product locator bar 3 is shown in FIG. 1, three product locator bars 3 are present in the rotary head 2. It should also be appreciated that various configurations or numbers of product locator bars 3 may be implemented in the rotary head 2.

During operation, the locating pin 1 may be pulled out of a detent stop (not shown in FIG. 1) and rotated into position. The locating pin 1 is then released. When released, locating pin 1 detents into the next position for the desired format. For example, if there are eight objects on a conveyor belt grouped as four groups of two, the product locator bar 3 shown in FIG. 1 may be used since the product locator bar 3 includes eight objects grouped in four groups of two.

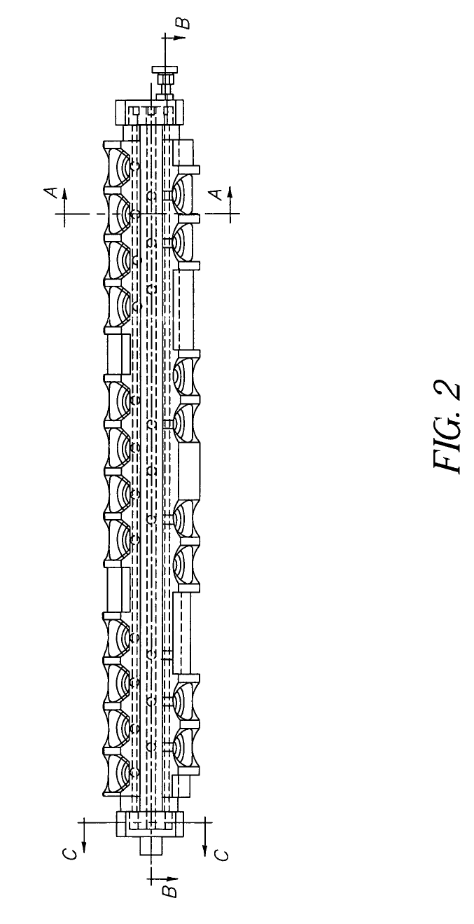

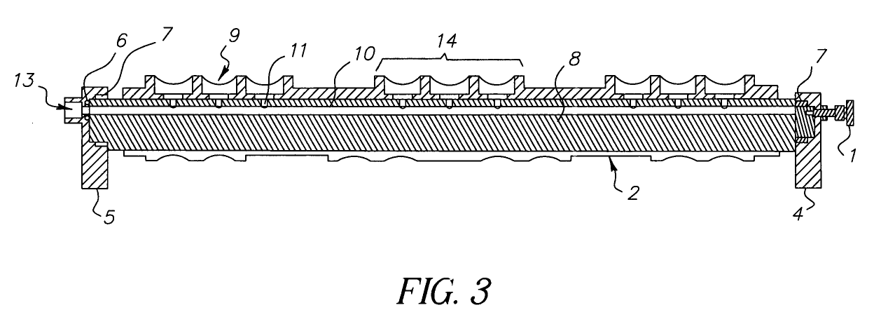

FIG. 2 is a bottom view of the three position rotary vacuum head showing two of the three different product locator bars. FIG. 3 is a cross-section of FIG. 2 along cross-section B-B showing one of the three internal chambers. The rotary head 2 also includes a rotatable-ported cylinder 8. The rotary head 2 is depicted showing the three-position rotary vacuum head 14, where each of the three positions in the three-position rotary vacuum head includes three vacuum cups 9. It should also be appreciated that two-position vacuum head and four-position vacuum heads may also be implemented.

The rotatable-ported cylinder 8 includes a cylinder passageway 10. The cylinder passageway 10 is in fluid communication with each vacuum cup 9 through a vacuum cup passageway 11. A vacuum insert passageway 13 provides a connection between the cylinder passageway 10 and a vacuum device (not shown). As a result, a suction force may be created across vacuum insert passageway 13, across the cylinder passageway 10, through vacuum cup passageway 11, to the vacuum cup 9. O-rings 6 enable the vacuum insert passageway 13 and the cylinder passageway 10 to interface (i.e., align) providing fluid communication between the two without communicating with any of the other cylinder passageways (not shown in FIG. 3).

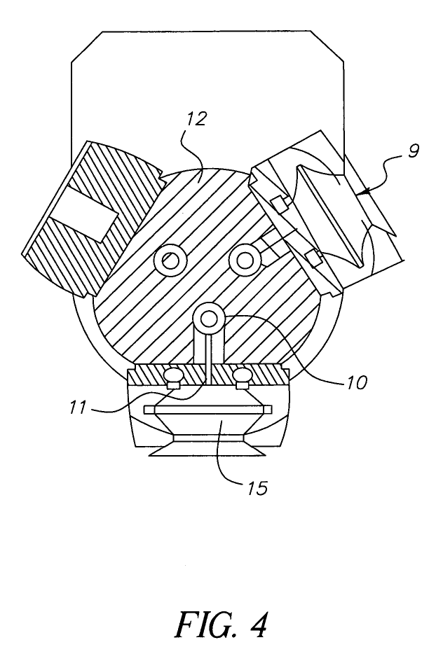

During operation, the inventive assembly presented in FIG. 3 may be used to perform very quick product changeover of various configurations. For example, it takes less than 15 seconds to change the assembly shown in FIG. 1 to a new format. Change over is accomplished by pulling the locating pin 1 out, spinning the rotary head 2 into position and then releasing the locating pin 1, which then detents into the next position for the desired format. The locating pin 1 lines up with three holes (i.e., detent stop 12 of FIG. 4) behind it and after rotating the rotary head 2, when the rotary head 2 rotates into a proper operating position for any of the three formats, the rotary head 2 locks into a positive stop. In one embodiment, the rotary head 2 is connected to an air cylinder, a bracket, and a frame.

The vacuum lines (i.e., 13, 10, 11) are used to create a suction force in the vacuum cups 9. The O-rings 6 seal against the rotary head 2 and allow three ports (i.e., one for each product locator bar 3) to be implemented; however, only one of them is getting vacuum and the others are sealed off. When the rotary head 2 is turned into position, the product locator bar 3 that you want to have running is the only product locator bar 3 that has vacuum on it.

The O-ring 6 seal provides a positive seal while still allowing rotational freedom of the rotary head 2. Plastic sleeve bearings 7 of FIG. 3 are pressed into the locating pin mounting block 4 and the vacuum inlet mounting block 5. By retracting the locating pin 1, rotating the rotary head 2 120°, and releasing the locating pin 1 a different product locator bar 3 of FIG. 1 is indexed into position.

FIG. 4 is a cross-section of FIG. 2 along section A-A detailing a cross-section of the rotary head 2, highlighting the vacuum cups 9. FIG. 4 shows three cylinder passageways 10. Each cylinder passageway 10 is connected to a vacuum cup passageway 11. Each vacuum cup passageway 11 is then connected to a vacuum cup 9. Further, a detent stop 12 is shown for receiving locating pin 1 of FIG. 1. The vacuum cup 9 bounds a vacuum chamber 15 which exist on the interior of the vacuum cup 9. The vacuum chamber 15 is connected to the cylinder passageway 10 through the vacuum cup passageway 11. As a result, the vacuum cup passageway 11 may be considered a chamber passageway. Suction is provided in the vacuum chamber 15 and an object is held into position by the vacuum cup 9 until the suction is discontinued.

During operation, vacuum is only applied to one cylinder passageway 10 at a time. When locating pin 1 is released, the locating pin 1 is inserted into the detent stop 12. During manufacturing, the detent stop 12 is configured so that the detent stop 12 provides a positive stop that allows the cylinder passageway 10 and the vacuum cup passageway 11 to align. The O-rings 6 of FIG. 3, stop vacuum from being applied to the other cylinder passageways. As a result, the locating pin 1, the detent stop 12, the cylinder passageway 10, and the vacuum cup passageway 11, work in an integrated manner to provide vacuum to one product locator bar 3 at one time.

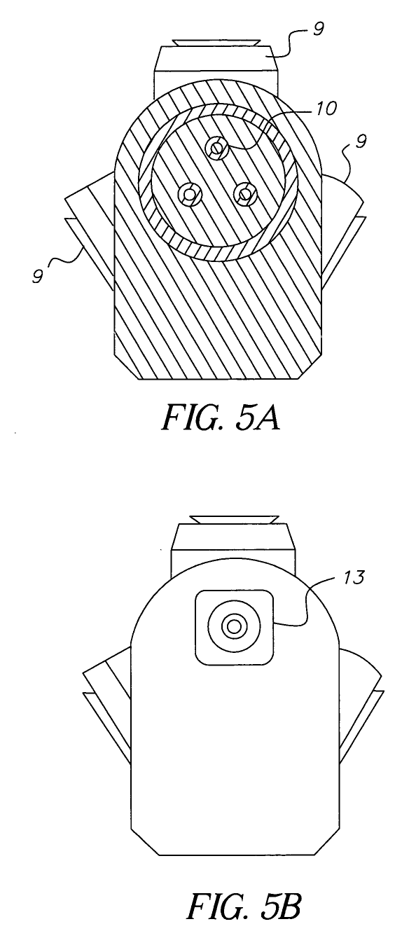

FIG. 5A is a cross-section of FIG. 2 along section C-C detailing a cross section of the inside of vacuum inlet mounting block 5. FIG. 5B is a cross-section of FIG. 2 along section C-C detailing a cross section of the outside of vacuum inlet mounting block 5. FIG. 5A shows each cylinder passageway 10. FIG. 5B shows a vacuum fitting 13 for receiving a vacuum and applying a suction force in the cylinder passageways 10 of FIG. 5A. The vacuum fitting 13 in the vacuum inlet mounting block 5 supplies vacuum to one of the three cylinder passageways 10 which are implemented at 120° intervals.

The invention has been described with reference to a preferred embodiment. However, it will be appreciated that variations and modifications can be effected by a person of ordinary skill in the art without departing from the scope of the invention.

### PARTS LIST

1 locating pin
2 rotary head
3 product locator bar
4 locating pin mounting block
5 vacuum inlet mounting block
6 o-ring seal
7 sleeve bearing
8 rotatable ported cylinder
9 vacuum cup
10 cylinder passageway
11 vacuum cup passageway
12 detent stop
13 vacuum fitting
14 three position vacuum heads
15 vacuum chamber

What is claimed is:

1. A vacuum element for product processing, comprising:
a rotary cylinder having at least one cylinder passageway for receiving a vacuum, said rotary cylinder having affixed to a circumferential portion thereof a plurality of spaced product holding members, each of said spaced product holding members comprising a plurality of cavities for at least partially enclosing a single product therein and a vacuum cup passageway extending beneath said plurality of cavities and connecting to the cylinder passageway;
whereby when any one of said spaced product holding members is rotated into fluid communications with said cylinder passageway, a select one of said product-holding members releasable retains the product in said plurality of cavities.

2. A vacuum element for product processing as set forth in claim 1, wherein the rotary cylinder includes at least one product locator bar and the plurality of spaced product holding members are positioned on the product locator bar.

3. A vacuum element for product processing as set forth in claim 1, wherein the vacuum element further comprises a detent pin interfacing with the rotary cylinder and causing the rotary cylinder to stop in a fixed position.

4. A vacuum element for product processing as set forth in claim 1, wherein the vacuum element further comprises a vacuum fitting coupled to said at least one cylinder passageway facilitating a suction force in said at least one cylinder.

5. A vacuum element for product processing as set forth in claim 1, wherein an O-ring is positioned as a seal to facilitate a suction force to one of said at least one cylinder passageway.

6. A vacuum element for product processing as set forth in claim 1, wherein each of the plurality of cavities is implemented with a vacuum cup.

7. A vacuum element for product processing as set forth in claim 1, wherein each of the plurality of spaced product holding members is implemented with a three position vacuum head.

8. A vacuum element for product processing as set forth in claim 1, wherein each of the plurality of spaced product holding members is implemented with a two-position vacuum head.

9. A vacuum element for product processing as set forth in claim 1, wherein each of the plurality of spaced product holding members is implemented with a four-position vacuum head.

10. A vacuum element for product processing, comprising:
a rotary head having a cylinder passageway deployed therein, the rotary head having affixed to a circumferential portion thereof a product locator bar, the product locator bar further comprising a vacuum head, the vacuum head including at least one vacuum chamber therein, the vacuum head including a chamber passageway coupling the vacuum chamber to the cylinder passageway;
whereby when the rotary head is rotated to a defined stop position, the chamber passageway is aligned with the cylinder passageway to provide a suction force in the vacuum chamber.

11. A vacuum element for product processing as set forth in claim 10, further comprising a detent stop positioned to facilitate the defined stop.

12. A vacuum element for product processing as set forth in claim 10, further comprising a locating pin positioned to facilitate the defined stop.

13. A vacuum element for product processing as set forth in claim 10, wherein the rotary head further comprises a second product locator bar affixed to a circumferential portion thereof, the second product locator bar further comprising a second vacuum head, the second vacuum head including at least one second vacuum chamber therein, the second vacuum head including a second chamber passageway coupling the second vacuum chamber to the cylinder passageway;
whereby when the rotary head is rotated to a second stop position, the second chamber passageway is aligned with the cylinder passageway to provide a suction force in the second vacuum chamber.

14. A vacuum element for product processing as set forth in claim 10, wherein the vacuum element further comprises a vacuum fitting coupled to the cylinder passageway facilitating a suction force in said at least one cylinder.

15. A vacuum element for product processing as set forth in claim 10, wherein an O-ring is positioned as a seal to facilitate the suction force in the cylinder passageway.

16. A vacuum element for product processing as set forth in claim 10, the vacuum head further comprising a vacuum cup bounding the vacuum chamber.

17. A vacuum element for product processing as set forth in claim 10, the product locator bar further comprising a second vacuum head for interfacing with a second object.

18. A vacuum element for product processing as set forth in claim 10, the product locator bar further comprising a second vacuum head for interfacing with a second object and a third vacuum head for interfacing with a third object.

19. A vacuum element for product processing, comprising:
a rotary head having a cylinder passageway deployed therein, the rotary head having affixed to a circumferential portion thereof a plurality of product locator bars, each of the plurality of product locator bars further comprising a plurality of vacuum heads, the plurality of vacuum heads each including at least one vacuum chamber therein, wherein each of the at least one vacuum chambers is coupled to a chamber passageway providing fluid communication between each of the at least one vacuum chambers and the cylinder passageway when the rotary head is rotated to a defined stop position.
